(19) United States
(12) Patent Application Publication
(10) Pub. No.: US 2015/0338810 A1
(43) Pub. Date: Nov. 26, 2015

(54) IMAGE FORMING DEVICE, IMAGE FORMING SYSTEM, IMAGE-FORMATION COMMANDING DEVICE, AND IMAGE FORMING METHOD

(71) Applicant: FUJI XEROX CO., LTD., Tokyo (JP)

(72) Inventors: Takayuki MATSUI, Kanagawa (JP); Hiroshi SHIOTA, Kanagawa (JP); Masateru HATTORI, Kanagawa (JP); Kazuhide KOBAYASHI, Kanagawa (JP); Satoshi KONDO, Kanagawa (JP)

(73) Assignee: FUJI XEROX CO., LTD., Tokyo (JP)

(21) Appl. No.: 14/560,529

(22) Filed: Dec. 4, 2014

(30) Foreign Application Priority Data
May 21, 2014 (JP) 2014-105149

(51) Int. Cl. G03G 15/00

(52) U.S. Cl. CPC G03G 15/5062

(57) ABSTRACT

An image forming apparatus includes a transport unit, an image forming unit, a detecting unit, a measuring unit, and a changing unit. The transport unit transports continuous paper. The image forming unit forms an image onto the continuous paper transported by the transport unit. The detecting unit transmits a detection signal every time the number of times a pulse signal, which is generated when the transport unit transports the continuous paper, is detected reaches a predetermined reference value. The measuring unit measures an amount of the continuous paper transported by the transport unit based on the detection signal from the detecting unit. The changing unit changes the reference value of the detecting unit in accordance with a transporting speed at which the continuous paper is transported by the transport unit.

### CROSS-REFERENCE TO RELATED APPLICATIONS

This application is based on and claims priority under 35 USC 119 from Japanese Patent Application No. 2014-105149 filed May 21, 2014.

### BACKGROUND

### Technical Field

The present invention relates to image forming devices, image forming systems, image-formation commanding devices, and image forming methods.

### SUMMARY

According to an aspect of the invention, there is provided an image forming apparatus including a transport unit, an image forming unit, a detecting unit, a measuring unit, and a changing unit. The transport unit transports continuous paper. The image forming unit forms an image onto the continuous paper transported by the transport unit. The detecting unit transmits a detection signal every time the number of times a pulse signal, which is generated when the transport unit transports the continuous paper, is detected reaches a predetermined reference value. The measuring unit measures an amount of the continuous paper transported by the transport unit based on the detection signal from the detecting unit. The changing unit changes the reference value of the detecting unit in accordance with a transporting speed at which the continuous paper is transported by the transport unit.

### BRIEF DESCRIPTION OF THE DRAWINGS

Exemplary embodiments of the present invention will be described in detail based on the following figures, wherein:

FIG. 1 illustrates a configuration example of an image forming system according to a first exemplary embodiment;

FIG. 2 illustrates a functional configuration example of a controller and an overall controller;

FIG. 3 is a flowchart illustrating a pulse-notification-interval changing function included in a notification-interval setting unit;

FIG. 4A is a timing chart illustrating an example of pulse-signal control in a print mode, and FIG. 4B is a timing chart illustrating an example of pulse-signal control in a transport mode;

FIG. 5 is a flowchart illustrating image forming operation according to a second exemplary embodiment;

FIG. 6 is a flowchart illustrating a count adjustment process according to the second exemplary embodiment;

FIG. 7A schematically illustrates continuous paper in a case where a separator is not inserted therein, and FIG. 7B schematically illustrates continuous paper in a case where a separator is inserted therein;

FIG. 8 is a flowchart illustrating a count adjustment process according to a third exemplary embodiment;

FIG. 9A schematically illustrates continuous paper prior to being reversely transported, and FIG. 9B schematically illustrates the continuous paper after being reversely transported; and

FIG. 10 is a flowchart illustrating a count adjustment process according to a fourth exemplary embodiment.

### DETAILED DESCRIPTION

Exemplary embodiments of the present invention will be described below in detail with reference to the appended drawings.

### First Exemplary Embodiment

### Image Forming System 1

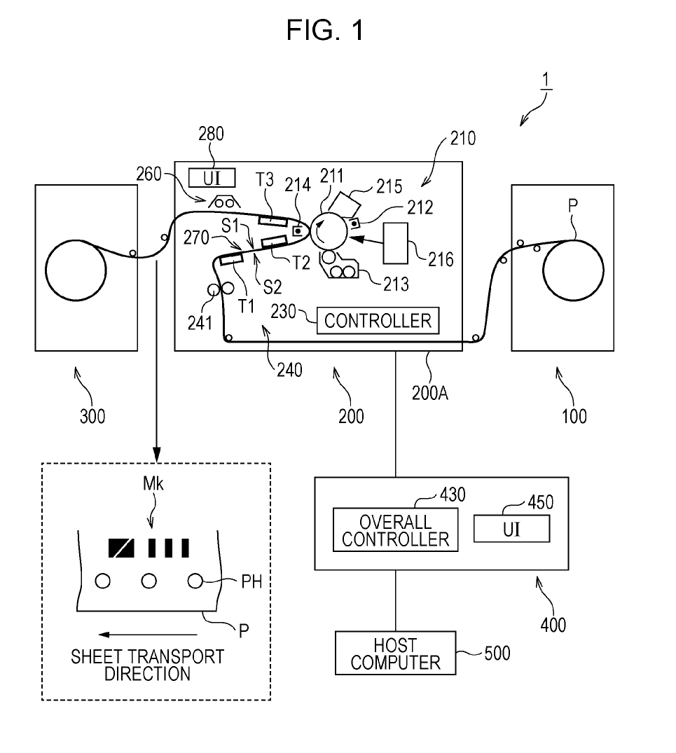

FIG. 1 illustrates a configuration example of an image forming system 1 according to a first exemplary embodiment.

As shown in FIG. 1, the image forming system 1 according to the first exemplary embodiment includes a sheet feeding device 100 that feeds continuous paper P, an image forming device 200 that forms an image onto the continuous paper P, and a winding device 300 that winds the continuous paper P on which the image is formed by the image forming device 200. Furthermore, the image forming system 1 also includes an overall control device 400 that controls the operation of the sheet feeding device 100, the image forming device 200, and the winding device 300, and a host computer 500 that controls the overall control device 400.

The sheet feeding device 100 as an example of a feeding device supports the continuous paper P wound in the shape of a roll and also feeds the continuous paper P to the image forming device 200. The sheet feeding device 100 includes a stepping motor (not shown) that serves as a driving source when feeding the continuous paper P wound in the shape of a roll, and also includes a detection sensor (not shown) that is provided in the transport path of the continuous paper P and that detects sagging of the continuous paper P. For example, when the continuous paper P is transported by the image forming device 200 and sagging of the continuous paper P is no longer detected by the detection sensor, the sheet feeding device 100 feeds the continuous paper P.

In the image forming system 1 according to the first exemplary embodiment, the continuous paper P used may be of a type that has feed holes (sprocket holes) PH as shown in FIG. 1 (i.e., pinhole continuous paper P) or a type that does not have the feed holes PH (i.e., pinhole-less continuous paper P).

Although the continuous paper P is described as being wound in the shape of a roll as an example, the continuous paper P used may be folded and be accommodated in, for example, a box.

The image forming device 200 has a device body 200A that contains therein an image forming section 210 that forms an image in correspondence with input image data and a controller 230 (which will be described later in detail) that controls the operation of each section and unit provided in the sheet feeding device 100 and the winding device 300 in addition to the image forming device 200. Furthermore, the image forming device 200 includes a sheet transport section 240 that discharges the transported continuous paper P outward via the image forming section 210, a fixing unit 260 that has, for example, a flash lamp and fixes a toner image formed on the continuous paper P by the image forming section 210, and a user interface (UI) 280 that receives information input by an operator and displays information to the operator.

The image forming section 210 as an example of an image forming unit is provided with a photoconductor drum 211 on which an electrostatic latent image is formed while the photoconductor drum 211 rotates in a direction indicated by an arrow in FIG. 1, a charging unit (charge corotron) 212 that electrostatically charges the surface of the photoconductor drum 211, a developing unit 213 that develops the electrostatic latent image formed on the photoconductor drum 211 by using toner, a transfer unit (transfer corotron) 214 that forms a transfer section where the toner image formed on the photoconductor drum 211 is transferred onto the continuous paper P, and a drum cleaner 215 that cleans the surface of the photoconductor drum 211 after the transfer process. Furthermore, the image forming section 210 is also provided with a laser exposure unit 216 that exposes the photoconductor drum 211 to light. The laser exposure unit 216 performs scan exposure on the photoconductor drum 211 by using laser light controlled based on acquired image data.

The sheet transport section 240 includes a back tension roller 241 that transports the continuous paper P to the image forming section 210. The sheet transport section 240 also includes an aligning roller (not shown) disposed downstream of the back tension roller 241 in the transport direction of the continuous paper P, and a guide wall (not shown) that is provided at the front side of the device body 200A and extends in the transport direction of the continuous paper P. The guide wall guides the continuous paper P. When transporting pinhole-less continuous paper P, the aligning roller positions the continuous paper P by bringing the continuous paper P into contact with the guide wall.

Furthermore, the sheet transport section 240 includes a first tractor T1 and a second tractor T2 that are provided downstream of the back tension roller 241 in the transport direction of the continuous paper P and that transport pinhole continuous paper P to the transfer section. Moreover, the sheet transport section 240 includes a third tractor T3 that transports the pinhole continuous paper P having passed through the transfer section toward the fixing unit 260. The sheet transport section 240 also includes a mark detection mechanism 270 that is provided between the first tractor T1 and the second tractor T2. The mark detection mechanism 270 has a first sensor S1 and a second sensor S2 and detects a mark Mk formed (printed) on the continuous paper P in the image forming device 200.

The winding device 300 as an example of a receiving device winds the continuous paper P discharged from the image forming device 200. The winding device 300 includes a stepping motor (not shown) that serves as a driving source when winding the continuous paper P into the shape of a roll, and also includes a detection sensor (not shown) that is provided in the transport path of the continuous paper P and that detects sagging of the continuous paper P. When the detection sensor detects sagging of the continuous paper P, the winding device 300 winds the continuous paper P.

The overall control device 400 as an example of an image-formation commanding device includes an overall controller 430 (which will be described later in detail) that controls the operation of the sheet feeding device 100, the image forming device 200, and the winding device 300, and also includes a user interface (UI) 450 that receives information input by the operator and displays information to the operator.

The host computer 500 is a computer that commands the sheet feeding device 100, the image forming device 200, and the winding device 300 to perform printing via the overall control device 400. The host computer 500 used may be, for example, a personal computer (PC).

Controller 230 and Overall Controller 430

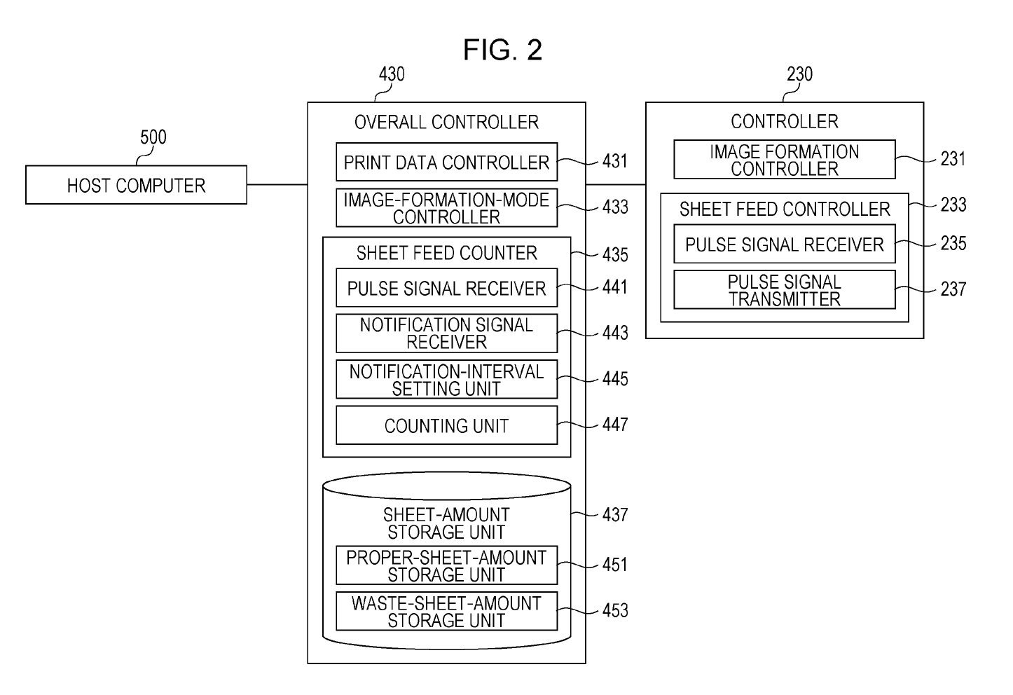

FIG. 2 illustrates a functional configuration example of the controller 230 and the overall controller 430.

Next, the controller 230 and the overall controller 430 will be described with reference to FIG. 2.

The controller 230 will be described first. The controller 230 includes an image formation controller 231 and a sheet feed controller 233 as functions thereof.

The image formation controller 231 receives a print command including image data from the overall controller 430 and controls the operation of the image forming section 210 that forms an image onto the continuous paper P in accordance with the received print command.

The sheet feed controller 233 receives the print command from the overall controller 430 and controls transportation of the continuous paper P by the sheet feeding device 100, the image forming device 200, and the winding device 300. In other words, the sheet feed controller 233 controls sheet feeding operation. The sheet feed controller 233 according to the first exemplary embodiment is capable of changing the transporting speed of the continuous paper P in the sheet feeding device 100, the image forming device 200, and the winding device 300. Specifically, the sheet feed controller 233 performs control for changing the transporting speed of the continuous paper P by switching between a high-speed transport mode in which the continuous paper P is transported at high speed and a low-speed transport mode in which the continuous paper P is transported at low speed.

The sheet feed controller 233 includes a pulse signal receiver 235 and a pulse signal transmitter 237 as functions thereof.

For example, the pulse signal receiver 235 receives a pulse signal output from the stepping motor (not shown) of the sheet feeding device 100 as an example of a transport unit.

The pulse signal transmitter 237 receives the pulse signal received by the pulse signal receiver 235 and transmits the pulse signal toward the overall controller 430.

Next, the overall controller 430 will be described. The overall controller 430 includes a print data controller 431, an image-formation-mode controller 433, a sheet feed counter 435, and a sheet-amount storage unit 437 as functions thereof.

The print data controller 431 controls print data to be formed on the continuous paper P. More specifically, the print data controller 431 receives image data transmitted from the host computer 500 and transmits the image data to the image formation controller 231. Furthermore, the print data controller 431 performs so-called image formation management, such as acquiring positional information of the continuous paper P in the sheet transport path from when an image is transferred onto the continuous paper P by the image forming section 210 based on each item of image data to when the continuous paper P is wound by the winding device 300.

The image-formation-mode controller 433 changes the mode of the image forming device 200. Specifically, the image-formation-mode controller 433 switches the mode of the image forming device 200 between a mode in which printing is performed on the continuous paper P and a mode in which printing is not performed, via the image formation controller 231 of the image forming device 200. Furthermore, the image-formation-mode controller 433 switches the mode of the image forming device 200 among a mode in which the continuous paper P is transported at high speed, a mode in which the continuous paper P is transported at low speed, and a mode in which the continuous paper P is stopped without being transported, via the sheet feed controller 233 of the image forming device 200.

More specifically, the image-formation-mode controller 433 according to the first exemplary embodiment switches the mode of the image forming device 200 among three modes, namely, a print mode, such as normal printing, in which printing is performed while the continuous paper P is transported at high speed, a transport mode, such as transportation and discharging of the continuous paper P, in which the continuous paper P is transported at low speed without undergoing printing, and a stop mode in which the continuous paper P is stopped without undergoing printing. Furthermore, the image-formation-mode controller 433 includes a mode storage unit (not shown) and stores the mode of the image forming device 200 into this mode storage unit.

The image-formation-mode controller 433 detects that an error has occurred in the sheet feeding device 100, the image forming device 200, and the winding device 300 based on detection signals of the continuous paper P from, for example, detection sensors (error detecting units) (not shown) provided in the sheet feeding device 100, the image forming device 200, and the winding device 300, or the first sensor S1 and the second sensor S2. Moreover, the image-formation-mode controller 433 has a function for changing the mode of the image forming device 200 in accordance with the detected error.

Examples of an error in the sheet feeding device 100, the image forming device 200, and the winding device 300 include a paper jam, cut continuous paper P (i.e., a paper-out state), broken (torn) continuous paper P, a transport defect, such as misregistration of the transported continuous paper P, and an image quality defect, such as a defective image.

The image-formation-mode controller 433 may store whether or not the continuous paper P is continuously transportable after the occurrence of an error. With reference to the above examples, for example, a paper jam or a paper-out state may be stored as an error in which the continuous paper P is not continuously transportable, whereas misregistration of the transported continuous paper P, torn continuous paper P, or a defective image may be stored as an error in which the continuous paper P is continuously transportable.

Furthermore, in accordance with the type of error, the image-formation-mode controller 433 may store whether a part that is printed prior to the occurrence of an error, that is, the continuous paper P in the sheet transport path, is acceptable as a proper sheet by the user. With reference to the above examples, for example, a paper jam, a paper-out state, torn continuous paper P, or a defective image may be stored as an error that is not acceptable as a proper sheet, whereas misregistration of the transported continuous paper P may be stored as an error that is acceptable as a proper sheet. The expression “continuous paper P in the sheet transport path” refers to, for example, a part thereof located downstream of the sheet feeding device 100 in the sheet transport direction and upstream of the winding device 300 in the sheet transport direction.

The sheet feed counter 435 measures the length of the transported continuous paper P in the transport direction (i.e., an amount of continuous paper P used). In the following description, the length of the continuous paper P in the transport direction may sometimes be described by being converted into the number of sheets (cut sheets) cut to a predetermined length (e.g., A4-size, B5-size, etc.). For example, the length of the transported continuous paper P in the transport direction may sometimes be simply referred to as the number of transported sheets.

The sheet feed counter 435 includes a pulse signal receiver 441, a notification signal receiver 443, a notification-interval setting unit 445, and a counting unit 447 as functions thereof.

The pulse signal receiver 441 as an example of a detecting unit is constituted of so-called hardware that physically receives a pulse signal transmitted from the sheet feed controller 233 of the controller 230. The pulse signal receiver 441 transmits a notification signal (detection signal) for every predetermined number of times (reference value) it receives a pulse signal from the sheet feed controller 233.

The notification signal receiver 443 is constituted of so-called software that receives the notification signal transmitted from the pulse signal receiver 441.

The notification-interval setting unit 445 as an example of a changing unit sets the timing for transmitting the notification signal from the pulse signal receiver 441 toward the notification signal receiver 443. This will be described later in detail.

The counting unit 447 as an example of a measuring unit counts the number of notification signals received by the notification signal receiver 443 and also causes the sheet-amount storage unit 437 to store the count value in accordance with the mode of the image forming device 200. This will be described later in detail. Furthermore, the counting unit 447 calculates a transport amount of the continuous paper P in accordance with the count value stored in the sheet-amount storage unit 437. This will be described later in detail.

The sheet-amount storage unit 437 stores the count value obtained by the counting unit 447. The sheet-amount storage unit 437 includes a proper-sheet-amount storage unit 451 and a waste-sheet-amount storage unit 453 as functions thereof.

Of count values obtained by the counting unit 447, the proper-sheet-amount storage unit 451 stores a count value of proper sheets. A proper sheet in this case refers to a part of the continuous paper P on which an image is properly formed in accordance with image data. In other words, such a proper sheet may also be referred to as a so-called assurance page assuring that an image is formed thereon by the image forming system 1 in accordance with image data.

Of count values obtained by the counting unit 447, the waste-sheet-amount storage unit 453 stores a count value of waste sheets. A waste sheet in this case refers to a sheet other than a proper sheet in the continuous paper P used, that is, a part other than the continuous paper P on which an image is properly formed. In other words, a waste sheet refers to a base sheet not turned into a final product (cut thin sheet). Examples of a waste sheet include a sheet transported without having an image formed thereon, a sheet having an image formed thereon but not treated as a proper sheet (e.g., a separator, which will be described later), and so on.

With regard to the switching between the proper-sheet-amount storage unit 451 and the waste-sheet-amount storage unit 453 into which the counting unit 447 stores count values, for example, the counting unit 447 may acquire information related to the mode of the image forming device 200 and perform the switching in accordance with the mode of the image forming device 200.

Although not shown, hardware of the controller 230 and hardware of the overall controller 430 are constituted as follows. Specifically, the controller 230 and the overall controller 430 each include a central processing unit (CPU) as an arithmetic unit, as well as a memory and a magnetic disk device (hard disk drive (HDD)) as storage units. The CPU executes various kinds of software, such as an operating system (OS) and an application, so as to realize the functions described above. The memory is a storage region that stores, for example, the various kinds of software and data to be used for executing the software. The magnetic disk device is a storage region that stores, for example, data input to the various kinds of software and data output from the various kinds of software.

Ascertainment of Amount of Continuous Paper Used

Generally, when the user using the continuous paper P measures the amount of continuous paper P used for printing performed based on a command for a series of image forming processes, that is, a so-called job, a roller having the continuous paper P wound therearound is sometimes used as a measurement unit, or a box that accommodates the continuous paper P may sometimes be used as a measurement unit in a case where folded continuous paper P is used, unlike in the example shown in FIG. 1. In this case, since it is difficult to measure a used amount that is smaller than or equal to the unit of the roller or the box, the measurement accuracy becomes lower.

Furthermore, the number of proper sheets, that is, the number of effective pages, with respect to a print job is sometimes measured. However, if the number of effective pages is measured, for example, in a multiple-connection configuration in which multiple image forming devices (not shown) are successively arranged is used or in a case where a pre-processing device (not shown) and a post-processing device (not shown) are respectively provided upstream and downstream of the image forming device in the transport direction, the amount of continuous paper P used for adjusting the continuous paper P in accordance with a change in the layout of the devices or the amount of continuous paper P non-usable at, for example, the joints of the continuous paper P in accordance with replacement of the continuous paper P increases, possibly resulting in lower measurement accuracy.

In the first exemplary embodiment, a transport amount (used amount) of a proper sheet having an image properly formed thereon is measured, and a transport amount (used amount) of a waste sheet, which is a sheet other than a proper sheet, is also measured. Based on a sum of the measured proper-sheet transport amount and the measured waste-sheet transport amount, a total used amount is measured.

A function and operation for measuring a transport amount of the continuous paper P in the image forming system 1 will be described below.

Pulse-Notification-Interval Changing Function

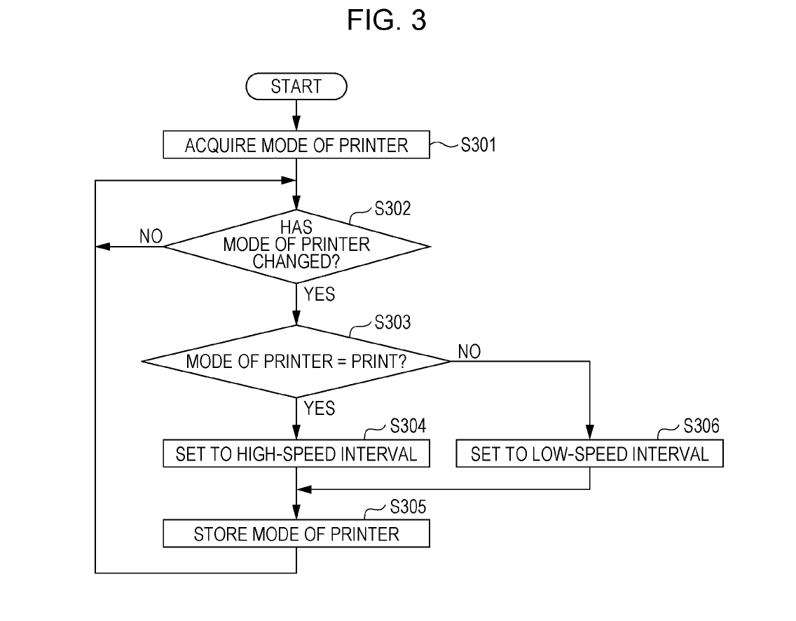

FIG. 3 is a flowchart illustrating a pulse-notification-interval changing function included in the notification-interval setting unit 445.

First, in the first exemplary embodiment, the counting unit 447 of the overall controller 430 counts the number of pulse signals transmitted from the pulse signal transmitter 237 so as to measure the transport amount of the continuous paper P. Generally, when an interval for acquiring pulse signals (i.e., sheet feed pulses) is shortened for increasing the measurement accuracy, the load on the CPU of the overall controller 430 increases, possibly affecting, for example, other processes controlled by the overall controller 430. On the other hand, although a configuration that cuts into the CPU of the overall controller 430 after receiving a specific number (specific amount) of pulse signals is conceivable, there is a possibility that it may be difficult to accurately measure the transport amount if the number of pulse signals does not reach the specific amount.

The notification-interval setting unit 445 according to the first exemplary embodiment changes a measurement mode for the continuous paper P in accordance with the mode of the image forming device 200. Specifically, the notification-interval setting unit 445 sets the timing for transmitting a notification signal from the pulse signal receiver 441 to the notification signal receiver 443. More specifically, in the first exemplary embodiment, the measurement mode for the continuous paper P is changed in accordance with the transporting speed of the continuous paper P by changing the number of times the pulse signal receiver 441 is to receive a pulse signal before it transmits a notification signal. Thus, even in a so-called ultra-high-speed printer, for example, the load on the overall controller 430 may be reduced, whereby an effect on other processes controlled by the overall controller 430 may be reduced.

In the following description, the expression “the number of times a pulse signal is received before a notification signal is transmitted” may sometimes be simply referred to as “pulse notification interval”.

The pulse-notification-interval changing function of the notification-interval setting unit 445 will be described below with reference to FIG. 3. It is assumed that the mode of the image forming device 200 is stored in advance in the mode storage unit (not shown) of the image-formation-mode controller 433.

First, in step S301, the notification-interval setting unit 445 receives a signal from the image-formation-mode controller 433 and acquires information related to the mode of the image forming device 200 at that point. Then, in step S302, it is determined whether the checked mode of the image forming device 200 matches the mode of the image forming device 200 stored in advance in an image-formation storage unit (not shown). In other words, it is determined whether the mode of the image forming device 200 has changed.

If the mode of the image forming device 200 has not changed (NO in step S302), the notification-interval setting unit 445 checks the mode of the image forming device 200 again in step S301.

If the mode of the image forming device 200 has changed (YES in step S302), the notification-interval setting unit 445 determines in step S303 whether the mode of the image forming device 200 is the print mode. If the mode of the image forming device 200 is the print mode (YES in step S303), the notification-interval setting unit 445 sets the pulse notification interval to a high-speed pulse notification interval in step S304 and makes the image-formation storage unit (not shown) store the mode of the image forming device 200 in step S305. Then, the notification-interval setting unit 445 checks the mode of the image forming device 200 again in step S301.

If the mode of the image forming device 200 is not the print mode (NO in step S303), the notification-interval setting unit 445 sets the pulse notification interval to a low-speed pulse notification interval in step S306 and makes the image-formation storage unit (not shown) store the mode of the image forming device 200 in step S305. Then, the notification-interval setting unit 445 checks the mode of the image forming device 200 again in step S301.

Pulse-Signal Control

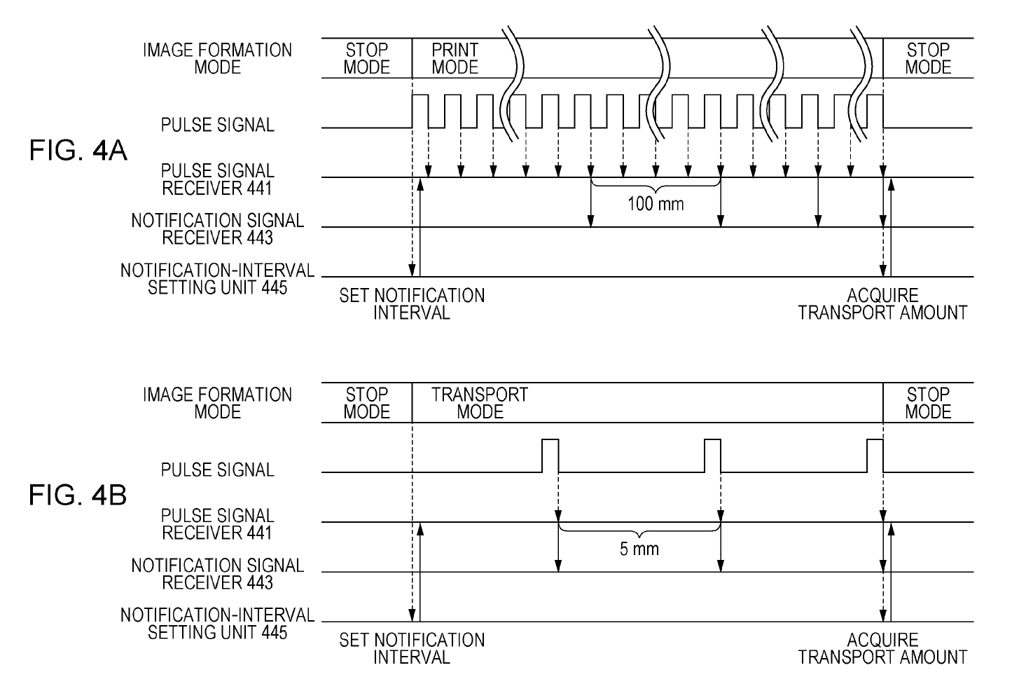

FIG. 4A is a timing chart illustrating an example of pulse-signal control in the print mode, and FIG. 4B is a timing chart illustrating an example of pulse-signal control in the transport mode.

Next, pulse-signal control will be described with reference to FIGS. 4A and 4B.

In the examples shown in FIGS. 4A and 4B, the high-speed pulse notification interval and the low-speed pulse notification interval are set as follows. Specifically, in the high-speed pulse notification interval, the pulse signal receiver 441 transmits a notification signal once every time the pulse signal receiver 441 receives a pulse signal 20 times. In the example shown in FIG. 4A, while a notification signal is transmitted once, that is, while the pulse signal receiver 441 receives a pulse signal 20 times, the continuous paper P is transported by 100 mm along the sheet transport path. This length by which the continuous paper P is transported per notification signal (100 mm in this example) may be stored in advance in, for example, the sheet-amount storage unit 437.

In the low-speed pulse notification interval, a notification signal is transmitted once at an interval shorter than the high-speed pulse notification interval, that is, every time the pulse signal receiver 441 receives a pulse signal once. In the example shown in FIG. 4B, while a notification signal is transmitted once, that is, while the pulse signal receiver 441 receives a pulse signal once, the continuous paper P is transported by 5 mm along the sheet transport path. This length by which the continuous paper P is transported per notification signal (5 mm in this example) may be stored in advance in, for example, the sheet-amount storage unit 437.

In FIG. 4A, the image formation mode changes from the stop mode to the print mode, in which printing is performed while the continuous paper P is transported at high speed, and subsequently changes to the stop mode again. When the mode of the image forming device 200 changes from the stop mode to the print mode, the pulse notification interval is set to the high-speed pulse notification interval by the notification-interval setting unit 445, and a count-value storage destination is set to the proper-sheet-amount storage unit 451 by the counting unit 447.

As the continuous paper P is transported, the pulse signal receiver 441 transmits a notification signal every time it receives a pulse signal 20 times. Furthermore, every time the notification signal receiver 443 receives a notification signal from the pulse signal receiver 441, the counting unit 447 updates the count value stored in the proper-sheet-amount storage unit 451 of the sheet-amount storage unit 437. Specifically, the count value in the proper-sheet-amount storage unit 451 is incremented by 1.

When the transportation of the continuous paper P stops, the pulse-signal transmission by the pulse signal transmitter 237 also stops.

In FIG. 4B, the image formation mode changes from the stop mode to the transport mode, in which the continuous paper P is transported at low speed without undergoing printing, and subsequently changes to the stop mode again. When the mode of the image forming device 200 changes from the stop mode to the transport mode, the pulse notification interval is set to the low-speed pulse notification interval by the notification-interval setting unit 445, and the count-value storage destination is set to the waste-sheet-amount storage unit 453 by the counting unit 447.

As the continuous paper P is transported, the pulse signal receiver 441 transmits a notification signal every time it receives a pulse signal once. Furthermore, every time the notification signal receiver 443 receives a notification signal from the pulse signal receiver 441, the counting unit 447 updates the count value stored in the waste-sheet-amount storage unit 453 of the sheet-amount storage unit 437. Specifically, the count value in the waste-sheet-amount storage unit 453 is incremented by 1.

When the transportation of the continuous paper P stops, the pulse-signal transmission by the pulse signal transmitter 237 also stops.

When a command from the user is received via, for example, the UI 450, the transport amount of the continuous paper P at that point is displayed on the UI 450 based on the count values stored in the proper-sheet-amount storage unit 451 and the waste-sheet-amount storage unit 453.

Specifically, when a command is received from the user, the counting unit 447 calculates a proper-sheet transport amount based on a product of the count value stored in the proper-sheet-amount storage unit 451 of the sheet-amount storage unit 437 and the length by which the continuous paper P is transported per notification signal in the print mode (100 mm in this example). Then, the calculated transport amount is displayed on, for example, the UI 450 as a proper-sheet transport amount (i.e., the number of transported sheets). Furthermore, the counting unit 447 calculates a waste-sheet transport amount based on a product of the count value stored in the waste-sheet-amount storage unit 453 of the sheet-amount storage unit 437 and the length by which the continuous paper P is transported per notification signal in the transport mode (5 mm in this example). Then, the calculated transport amount is displayed on, for example, the UI 450 as a waste-sheet transport amount (i.e., the number of transported sheets). Moreover, the counting unit 447 calculates a sum of the proper-sheet transport amount and the waste-sheet transport amount and displays a total transport amount (i.e., total used amount) including both the proper-sheet transport amount and the waste-sheet transport amount on, for example, the UI 450.

Although the high-speed pulse notification interval (i.e., the reference value) is set to be larger than the low-speed pulse notification interval in the above description, for example, the high-speed pulse notification interval (i.e., the reference value) may alternatively be set to be smaller than the low-speed pulse notification interval.

Furthermore, although the notification-interval setting unit 445 is configured to change the pulse notification interval in accordance with the mode of the image forming device 200 in the above description, for example, the pulse notification interval may alternatively be changed in accordance with a mode in which the image forming section 210 performs printing on the continuous paper P and a mode in which the image forming section 210 does not perform printing on the continuous paper P. As another alternative, the pulse notification interval may be changed in accordance with a mode in which the continuous paper P is transported at high speed and a mode in which the continuous paper P is transported at low speed.

### Second Exemplary Embodiment

Next, a second exemplary embodiment will be described.

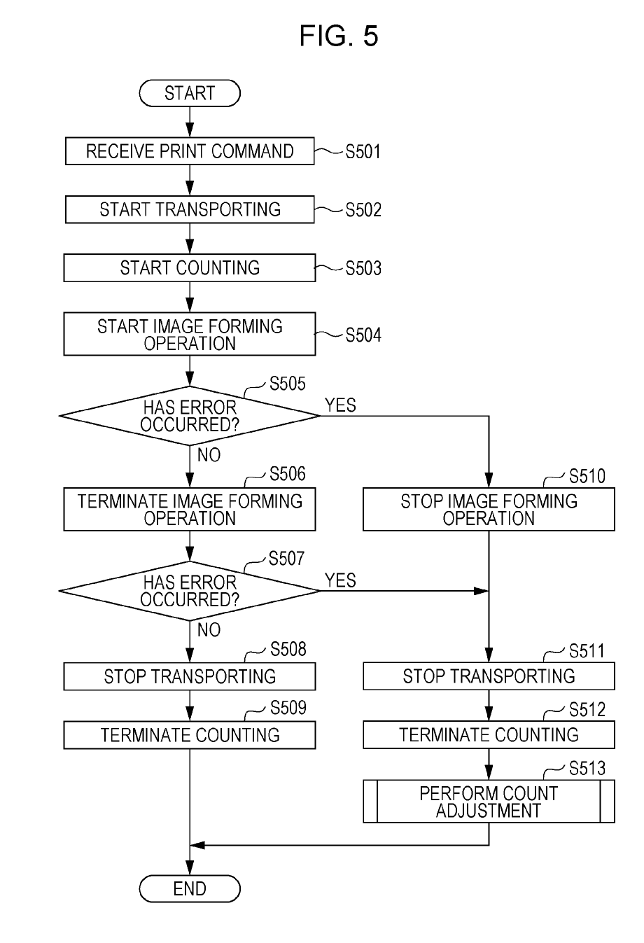

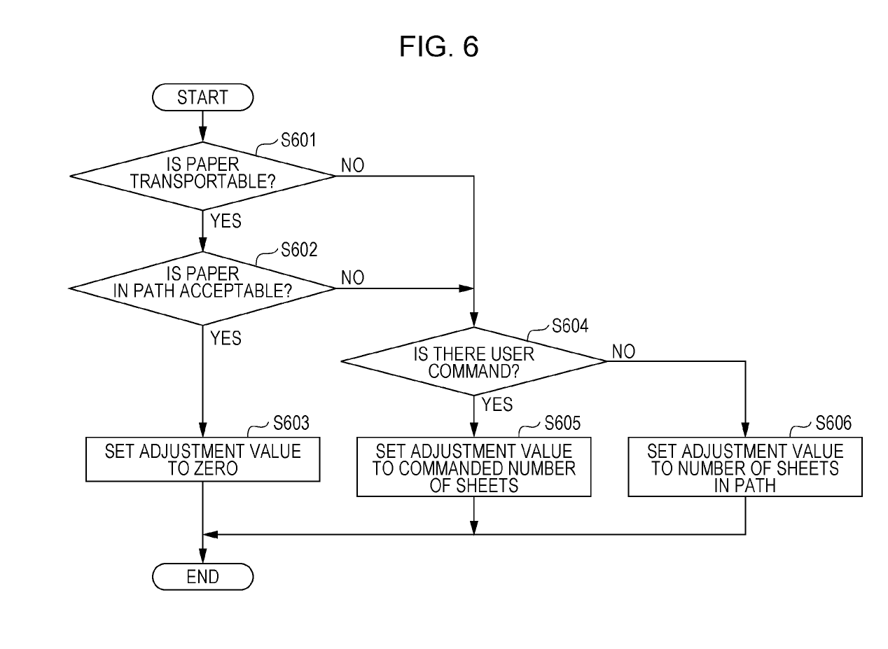

FIG. 5 is a flowchart illustrating image forming operation according to the second exemplary embodiment. FIG. 6 is a flowchart illustrating a count adjustment process according to the second exemplary embodiment.

In the first exemplary embodiment described above, a proper-sheet transport amount and a waste-sheet transport amount are measured based on pulse signals. Generally, when an error, such as a paper jam, occurs in image forming operation, there is a possibility that the accuracy of a transport amount to be measured may decrease. In the second exemplary embodiment, when an error occurs in the image forming operation, a transport-amount adjustment process is performed.

Specifically, as shown in FIG. 5, when the print data controller 431 receives a print command from, for example, the host computer 500 in step S501, the sheet feed controller 233 starts transporting the continuous paper P in step S502. As the continuous paper P is transported, the pulse signal receiver 441 transmits a pulse signal, and the counting unit 447 starts counting notification signals (pulse signals) in step S503. Then, the image forming section 210 of the image forming device 200 starts performing image forming operation in step S504. As described above, the pulse notification interval is set to the high-speed pulse notification interval when the image forming device 200 is in the print mode, and is set to the low-speed pulse notification interval when the image forming device 200 is in the transport mode.

Subsequently, the image-formation-mode controller 433 determines in step S505 whether or not an error has occurred. If an error has not occurred (NO in step S505), the print data controller 431 detects a termination of the image forming operation in step S506, and the image-formation-mode controller 433 determines whether or not an error has occurred with the termination of the image forming operation in step S507. Then, if an error has not occurred (NO in step S507), the sheet feed controller 233 stops transporting the continuous paper P in step S508. As a result of this stopping of the transportation of the continuous paper P, the pulse-signal counting process by the counting unit 447 ends in step S509.

On the other hand, if an error has occurred (YES in step S505), the image-formation-mode controller 433 stops the image forming operation and changes the mode of the image forming device 200 from the print mode to the transport mode in step S510, and then stops the transportation of the continuous paper P and changes the mode of the image forming device 200 from the transport mode to the stop mode in step S511. As a result of this stopping of the transportation of the continuous paper P, the pulse-signal counting process by the counting unit 447 ends in step S512. Then, the counting unit 447 performs a count adjustment process (i.e., a transport-amount adjustment process). This count adjustment process will be described later.

If an error has occurred with the termination of the image forming operation (YES in step S507), the sheet feed controller 233 stops transporting the continuous paper P and changes the mode of the image forming device 200 from the transport mode to the stop mode in step S511, and the pulse-signal counting process by the counting unit 447 ends in step S512. Then, the counting unit 447 performs a count adjustment process (i.e., a transport-amount adjustment process).

With the image forming operation described above, a count value of proper sheets on which images are properly formed is stored into the proper-sheet-amount storage unit 451 by the counting unit 447, and a count value of waste sheets on which images are not formed is stored into the waste-sheet-amount storage unit 453 by the counting unit 447.

Next, the count adjustment process will be described with reference to FIG. 6.

As shown in FIG. 6, the counting unit 447 as an example of an adjusting unit determines in step S601 whether or not the continuous paper P is transportable in accordance with the type of error detected by the image-formation-mode controller 433. If the continuous paper P is transportable (YES in step S601), the counting unit 447 determines in step S602 whether or not the type of error detected by the image-formation-mode controller 433 indicates that the continuous paper P in the path is acceptable as a proper sheet. If the continuous paper P in the path is acceptable as a proper sheet (YES in step S602), an adjustment value for count adjustment is set to zero in step S603. In other words, the process ends without performing count adjustment.

On the other hand, if the continuous paper P is not transportable (NO in step S601) or if the continuous paper P in the path is not acceptable as a proper sheet (NO in step S602), the counting unit 447 determines in step S604 whether or not there is a user command with respect to an adjustment value (i.e., a commanded number of sheets) for count adjustment associated with the occurrence of an error. An example of a user command in this case includes receiving a designated page number, from which printing is to be resumed, from the user within, for example, a predetermined period (time) from when the error occurs. A difference between the resuming page number designated by the user and a page number that has previously undergone printing corresponds to a commanded number of sheets, which will be described later.

If there is a user command, the commanded number of sheets from the user is set as the adjustment value in step S605. Specifically, the transport amount of the continuous paper P corresponding to the commanded number of sheets is added to the waste-sheet transport amount, and the transport amount of the continuous paper P corresponding to the commanded number of sheets is subtracted from the proper-sheet transport amount.

If there is no user command, the number of proper sheets remaining in the path (i.e., the number of sheets in the path) and detected by, for example, a sensor (not shown) provided in the transport path of the continuous paper P is set as the adjustment value in step S606. Specifically, the transport amount of the continuous paper P corresponding to the number of sheets in the path is added to the waste-sheet transport amount, and the transport amount of the continuous paper P corresponding to the number of sheets in the path is subtracted from the proper-sheet transport amount.

Although the above description relates to a case where an error occurs in the image forming operation, the above-described process is also applicable to a case where an error occurs when performing sheet transport operation that does not involve image formation.

### Third Exemplary Embodiment

Next, a third exemplary embodiment will be described.

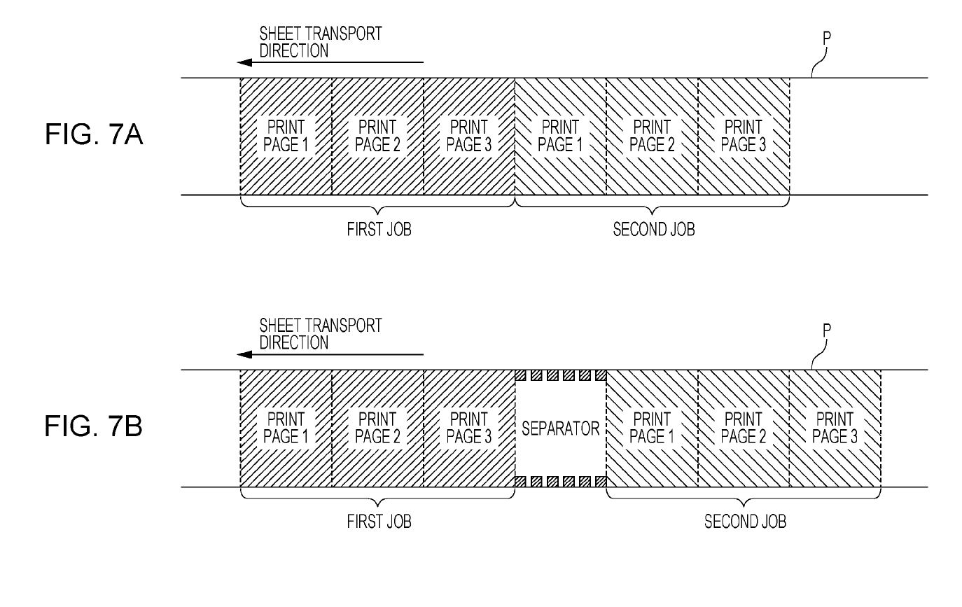

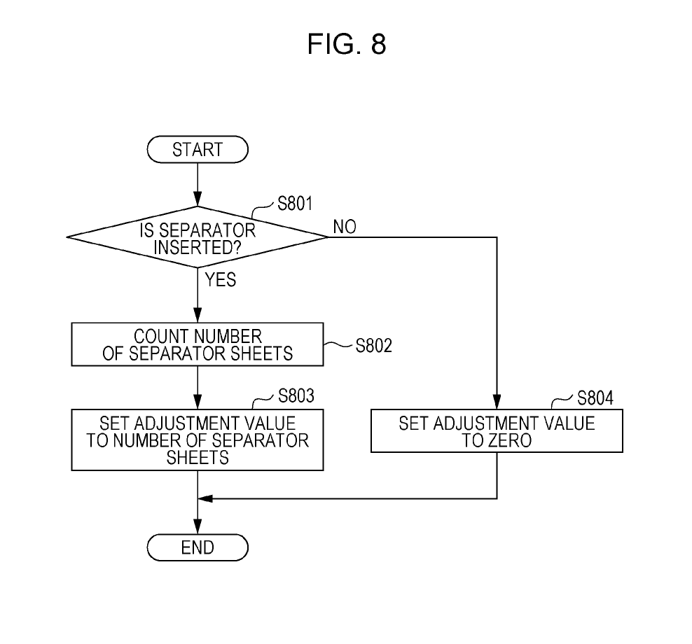

FIG. 7A schematically illustrates continuous paper P in a case where a separator is not inserted therein, and FIG. 7B schematically illustrates continuous paper P in a case where a separator is inserted therein. FIG. 8 is a flowchart illustrating a count adjustment process according to the third exemplary embodiment.

In the second exemplary embodiment described above, a proper-sheet count value (i.e., a proper-sheet transport amount) and a waste-sheet count value (i.e., a waste-sheet transport amount) are adjusted based on the type of error that has occurred. This transport-amount adjustment process is not limited to a process performed in accordance with the type of error that has occurred and may be performed based on other conditions. In the third exemplary embodiment, the count-value (transport-amount) adjustment process is performed in accordance with whether or not a separator is to be inserted.

First, a separator will be described. If multiple jobs (i.e., image forming processes) are to be successively executed in the image forming system 1, a separator for determining a breakpoint between jobs is sometimes inserted between sheets on which images are formed based on the respective jobs. This separator is a part that is inserted between parts (i.e., images) in the continuous paper P where image formation is performed in accordance with jobs. By inserting the separator between sheets having images formed thereon, for example, the user may readily determine a breakpoint between jobs.

For example, as shown in FIG. 7B to be described later, the separator is a predetermined image formed at opposite edges in a direction intersecting the sheet transport direction. The separator in the example shown in FIG. 7B is formed to have a predetermined width at the opposite edges of the continuous paper P in the direction intersecting the transport direction and is formed as an image with colored regions and uncolored regions alternately repeating in the sheet transport direction.

Whether or not to insert this separator is designated by receiving a command from the user via, for example, the UI 450 (see FIG. 1). Then, for example, the print data controller 431 inserts data for forming the separator into print data to be formed on the continuous paper P. Furthermore, the data for forming the separator contains information indicating that the separator is to be treated as a proper sheet or a waste sheet. In the example shown in FIG. 7B, the data for forming the separator contains information indicating that the separator is to be treated as a waste sheet. In other words, in the example shown in FIG. 7B, the separator is an example of a sheet treated as a waste sheet in the continuous paper P having images formed thereon by the image forming unit.

More specifically, in the example shown in FIG. 7A in which a separator is not inserted, images based on a second job (i.e., first to third pages) are formed starting from a position continuing from images formed on the continuous paper P based on a first job (i.e., first to third pages in FIG. 7A), that is, from a position immediately after the images formed based on the first job.

In the example shown in FIG. 7B in which a separator is inserted, the separator is inserted between the images formed on the continuous paper P based on the first job (i.e., first to third pages in FIG. 7B) and the images formed based on the second job (i.e., first to third pages in FIG. 7B).

Because the first job, the separator, and the second job are executed as a series of image forming processes, the image forming device 200 is maintained in the print mode (i.e., a mode in which transportation is performed at high speed). Therefore, the set of sheets corresponding to the first job, the separator, and the second job are all counted as proper sheets. On the other hand, since the sheet having the separator formed thereon does not have an originally-intended image formed thereon, the separator has to be counted as a waste sheet.

In the third exemplary embodiment, a transport-amount adjustment process is performed in accordance with whether or not a separator is to be formed.

Specifically, as shown in FIG. 8, the counting unit 447 determines in step S801 whether or not a separator has been inserted by the print data controller 431.

If a separator has been inserted (YES in step S801), the counting unit 447 counts the number of separator sheets inserted by the print data controller 431 in step S802. Then, the counting unit 447 sets the number of inserted separator sheets as an adjustment value in step S803. Specifically, the transport amount of the continuous paper P corresponding to the number of separator sheets is added to the waste-sheet transport amount, and the transport amount of the continuous paper P corresponding to the number of separator sheets is subtracted from the proper-sheet transport amount.

If a separator is not inserted (NO in step S801), the adjustment value is set to zero in step S804. In other words, the process ends without performing count adjustment.

Although the above description relates to a case where a separator is used, the third exemplary embodiment may be applied when there is a sheet that has to be treated as a waste sheet, such as an image adjustment sheet or a test sheet, while performing image forming operation.

Furthermore, although the above description relates to a case where a separator is formed as an image printed at the opposite edges in the direction intersecting the sheet transport direction, the separator may be formed as a predetermined image that indicates that the sheet is a separator, such as a symbol or a character, or may be formed as a blank sheet on which an image is not formed. In the case where the separator is a blank sheet, for example, the mode in which the continuous paper P is transported at high speed may be maintained when executing the first job, the separator, and the second job.

Furthermore, the third exemplary embodiment may be executed after step S509 or step S513 in FIG. 5 and immediately before the end of the process.

### Fourth Exemplary Embodiment

Next, a fourth exemplary embodiment will be described.

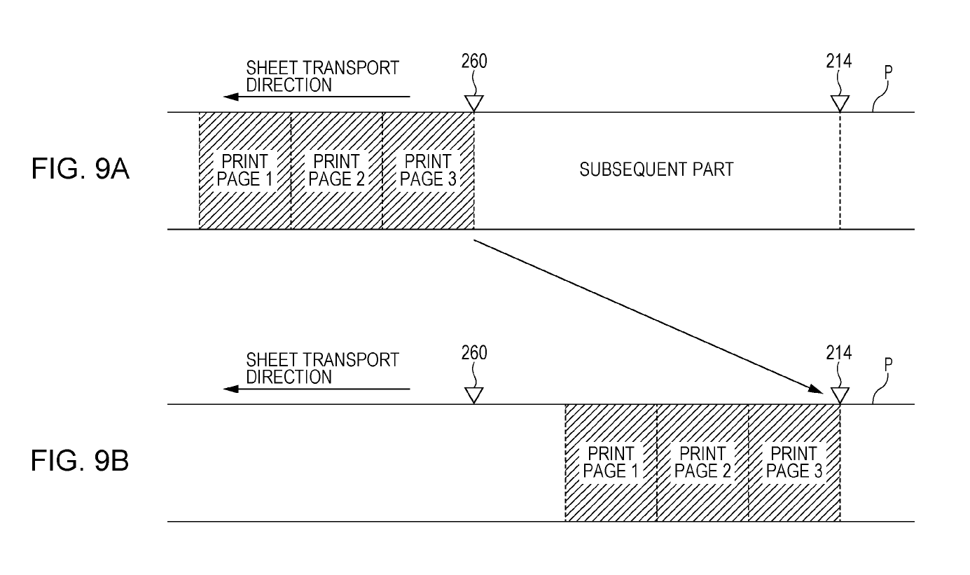

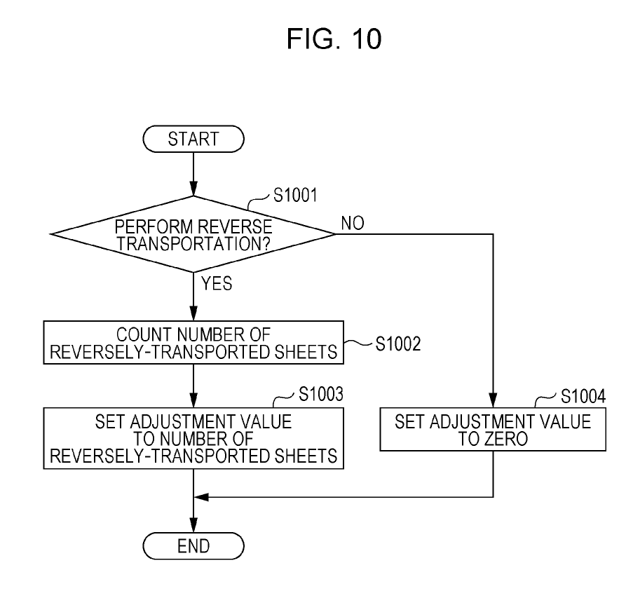

FIG. 9A schematically illustrates continuous paper P prior to being reversely transported, and FIG. 9B schematically illustrates the continuous paper P after being reversely transported. FIG. 10 is a flowchart illustrating a count adjustment process according to the fourth exemplary embodiment.

The second exemplary embodiment described above relates to a case where the proper-sheet transport amount and the waste-sheet transport amount are adjusted based on the type of error that has occurred, and the third exemplary embodiment described above relates to a case where the proper-sheet transport amount and the waste-sheet transport amount are adjusted in accordance with whether or not a separator is to be inserted. In the fourth exemplary embodiment, a transport-amount adjustment process is performed in accordance with whether or not reverse transportation is to be performed.

First, reverse transportation will be described. For example, as shown in FIG. 9A, a leading end of a subsequent part is transported to and stopped at the fixing unit 260 while the image forming device 200 is maintained in the print mode so that an image fixing process is performed by the fixing unit 260 on a final sheet (i.e., a third page in FIG. 9A) on which an image is formed based on a job.

In this case, since the subsequent part does not have an image formed thereon, for example, the continuous paper P is sometimes reversely transported to a second predetermined position so as to reduce the amount of continuous paper P used. Specifically, for example, as shown in FIG. 9B, the image-formation-mode controller 433 as an example of a reverse transport unit reversely transports the leading end of the subsequent part to the transfer unit 214 via the sheet feed controller 233.

Whether or not to perform reverse transportation is designated by receiving a command from the user via, for example, the UI 450 (see FIG. 1) before image forming operation starts. Then, for example, the print data controller 431 receiving the command from the user adds data related to reverse transportation and a reverse transport length (i.e., transport amount) to print data to be formed on the continuous paper P.

In the example shown in FIG. 9B, subsequent sheets between the transfer unit 214 and the fixing unit 260 (i.e., between the predetermined position and the second predetermined position) are counted as proper sheets when transported in the sheet transport direction. On the other hand, when reverse transportation is performed, the reversely-transported sheets return to positions located upstream in the transport direction. Thus, determination of whether these subsequent sheets are treated as proper sheets or waste sheets varies depending on the subsequent mode of the image forming device 200.

In the fourth exemplary embodiment, a transport-amount adjustment process is performed in accordance with whether or not reverse transportation is to be performed.

Specifically, as shown in FIG. 10, the counting unit 447 determines whether or not data related to reverse transportation is added to print data in step S1001.

If data related to reverse transportation is added (YES in step S1001), the counting unit 447 measures the reverse transport amount, that is, the number of reversely-transported sheets, in accordance with the data related to reverse transportation in step S1002. Then, the counting unit 447 sets the number of reversely-transported sheets as an adjustment value in step S1003. In other words, the transport amount of the continuous paper P corresponding to the number of reversely-transported sheets is subtracted from the proper-sheet transport amount. Since it is difficult to determine at this point whether or not image formation has been performed on a part of the continuous paper P corresponding to the number of reversely-transported sheets, a process for adding the number of reversely-transported sheets to the waste-sheet transport amount is not performed.

If data related to reverse transportation is not added (NO in step S1001), the adjustment value is set to zero in step S1004. In other words, the process ends without performing count adjustment.

Although omitted in the above description, there is a case where the actual reverse transportation is not performed even when a command for reverse transportation is received. For example, reverse transportation is not performed when an emergency shutdown is performed for immediately stopping a sheet transporting process from a safety standpoint. Thus, even when a command for reverse transportation is received, the counting unit 447 may determine whether or not reverse transportation has been performed. If the actual reverse transportation is not performed, the adjustment value may be set to zero (see step S1004). In other words, the process may be terminated without performing count adjustment.

Furthermore, the fourth exemplary embodiment may be executed after step S509 or step S513 in FIG. 5 and immediately before the end of the process.

### MODIFICATIONS

In the above description, a pulse signal is acquired by using the stepping motor of the sheet feeding device 100. Alternatively, a pulse signal from a stepping motor of another device, such as the image forming device 200 or the winding device 300, may be used so long as a pulse signal is generated when the continuous paper P is transported. Furthermore, as an alternative to a stepping motor, a signal from a detector may be used, such as a sensor that detects passing of the feed holes PH shown in FIG. 1, so long as a pulse signal is detectable.

Although the above description relates to a configuration in which the winding device 300 winds the continuous paper P having undergone image formation, a configuration that folds and accommodates the continuous paper P or a configuration that cuts the continuous paper P for every image and subsequently stacks the cut sheets is also permissible.

Furthermore, although each of the above exemplary embodiments relates to an example of a printing device that performs printing on the continuous paper P (i.e., a continuous medium), each of the above exemplary embodiments and modifications may also be applied to cut sheets that have been cut to a predetermined size.

Furthermore, although each of the above exemplary embodiments relates to a case where the sheet feeding device 100, the image forming device 200, and the winding device 300 are provided as separate devices, these devices may be integrated into a single image forming apparatus.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
a transport unit that transports continuous paper;
an image forming unit that forms an image onto the continuous paper transported by the transport unit;
a detecting unit that transmits a detection signal every time the number of times a pulse signal, which is generated when the transport unit transports the continuous paper, is detected reaches a predetermined reference value;
a measuring unit that measures an amount of the continuous paper transported by the transport unit based on the detection signal from the detecting unit; and
a changing unit that changes the reference value of the detecting unit in accordance with a transporting speed at which the continuous paper is transported by the transport unit.

2. The image forming apparatus according to claim 1,
wherein when the speed at which the continuous paper is transported by the transport unit is high, the changing unit increases the reference value relative to when the speed is low.

3. The image forming apparatus according to claim 1,
wherein the measuring unit measures an amount of proper sheet, on which a predetermined image is formed by the image forming unit, and an amount of waste sheet, which is a sheet other than the proper sheet.

4. The image forming apparatus according to claim 3,
wherein the measuring unit determines a sheet to be treated as the waste sheet in the continuous paper on which the image is formed by the image forming unit, and measures the amount of proper sheet and the amount of waste sheet based on a result of the determination.

5. The image forming apparatus according to claim 1, further comprising:
an error detecting unit that detects an error; and
an adjusting unit that adjusts the amount of continuous paper measured by the measuring unit, when the error detecting unit detects the error, in accordance with whether or not the continuous paper is transportable in a state where the detected error has occurred.

6. The image forming apparatus according to claim 1, further comprising:
a reverse transport unit that reversely transports the continuous paper in a direction opposite to a direction in which the continuous paper is transported by the transport unit; and
an adjusting unit that adjusts the amount of continuous paper measured by the measuring unit in accordance with reverse transportation performed by the reverse transport unit.

7. An image forming system comprising:
a feeding device that feeds continuous paper;
a transport unit that transports the continuous paper fed from the feeding device;
an image forming unit that forms an image onto the continuous paper transported by the transport unit;
a detecting unit that transmits a detection signal every time the number of times a pulse signal, which is generated when the transport unit transports the continuous paper, is detected reaches a predetermined reference value;
a measuring unit that measures an amount of proper sheet, on which a predetermined image is formed by the image forming unit, and an amount of waste sheet, which is a sheet other than the proper sheet, based on the detection signal from the detecting unit and a timing at which the image is formed by the image forming unit; and
a receiving device that receives the continuous paper on which the image is formed by the image forming unit.

8. An image-formation commanding apparatus comprising:
a detecting unit that receives a pulse signal generated when continuous paper is transported by a transport unit, which is provided in an image forming device and transports the continuous paper, and that transmits a detection signal every time the number of times the pulse signal is detected reaches a predetermined reference value;
a measuring unit that measures an amount of the continuous paper transported by the transport unit based on the detection signal from the detecting unit; and
a changing unit that changes the reference value of the detecting unit in accordance with a transporting speed at which the continuous paper is transported by the transport unit.

9. An image forming method comprising:
transporting continuous paper;
forming an image onto the transported continuous paper;
transmitting a detection signal every time the number of times a pulse signal, which is generated when the continuous paper is transported, is detected reaches a predetermined reference value;
measuring an amount of the transported continuous paper based on the detection signal; and
changing the reference value in accordance with a transporting speed at which the continuous paper is transported.
